(19) United States
(12) Patent Application Publication
(10) Pub. No.: US 2010/0205609 A1
(43) Pub. Date: Aug. 12, 2010

(54) USING TIME STAMPS TO FACILITATE LOAD REORDERING

(75) Inventor: Robert E. Cypher, Saratoga, CA (US)

Correspondence Address: PVF -- ORACLE AMERICA, INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/369,426

(22) Filed: Feb. 11, 2009

(51) Int. Cl. G06F 9/46

(52) U.S. Cl. 718/105

(57) ABSTRACT

Some embodiments of the present invention provide a system that supports load reordering in a processor. The system maintains at least one counter value for each thread which is used to assign time stamps for the thread. While performing a load for the thread, the system reads a time stamp from a cache line to which the load is directed. Next, if the counter value is equal to the time stamp, the system performs the load. Otherwise, if the counter value is greater-than the time stamp, the system performs the load and increases the time stamp to be greater-than-or-equal-to the counter. Finally, if the load is a speculative load, which is speculatively performed earlier than an older load in program order, and the counter value is less-than the time stamp, the system fails speculative execution for the thread.

### BACKGROUND

1. Field

The present invention generally relates to the design of processors within computer systems. More specifically, the present invention relates to a processor which uses time stamps to facilitate load reordering.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, and is beginning to create significant performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

Efficient caching schemes can help reduce the number of memory accesses that are performed. However, when a memory reference, such as a load, generates a cache miss, the subsequent access to level-two (L2) cache or memory can require dozens or hundreds of clock cycles to complete, during which time the processor is typically idle, performing no useful work.

In order to perform useful work during a cache miss, some processors support “load reordering,” which enables a subsequent load to take place even if one or more preceding loads have not completed. A number of techniques have been proposed to support load reordering.

For example, under a first technique, a processor can use dedicated hardware to keep track of addresses for “speculative loads” for a thread (wherein speculative loads are loads that are performed earlier than an older load in program order). If a store from another processor subsequently interferes with a speculative load, speculative execution fails, which causes the thread to back up to a preceding checkpoint.

Under a second technique, instead of keeping track of speculative load addresses, metadata in cache lines in the L1 data cache can be used to indicate whether an associated cache line has been speculatively read. This metadata can be subsequently used to detect interfering stores. However, if a cache line is evicted, associated speculatively executing threads must fail, even if no other threads have stored to the cache line.

Under a third technique, a processor can place “load marks” on cache lines to prevent other threads from storing to the cache line. (For example, see U.S. patent Ser. No. 11/591,225, entitled “Facilitating Load Reordering through Cacheline Marking,” by inventor Robert Cypher, filed 31 Oct. 2006.) However, under this technique, the system must keep track of cache lines with load marks to be able to remove the load marks in the future.

Unfortunately, because of resource constraints the above-described techniques can only keep track of a bounded number of speculative loads.

Hence, what is needed is a method and an apparatus that supports load reordering without the drawbacks of the above-described techniques.

### SUMMARY

Some embodiments of the present invention provide a system that supports load reordering in a processor. The system maintains at least one counter value for each thread which is used to assign time stamps for the thread. While performing a load for the thread, the system reads a time stamp from a cache line to which the load is directed. Next, if the counter value is equal to the time stamp, the system performs the load. Otherwise, if the counter value is greater than the time stamp, the system performs the load and increases the time stamp to be greater-than-or-equal-to the counter. Finally, if the load is a speculative load, which is speculatively performed earlier than an older load in program order, and the counter value is less-than the time stamp, the system fails speculative execution for the thread.

In some embodiments, if the load is a non-speculative load and the counter value is less-than the time stamp, the system performs the load and increases the counter value to be greater-than-or-equal-to the time stamp.

In some embodiments, the processor supports a sequential consistency (SC) memory model, wherein the thread maintains a single counter value which is used to assign time stamps for both loads and stores. In these embodiments, time stamps for loads and stores are assigned in non-decreasing order.

In some embodiments, the thread maintains a counter value L for assigning time stamps for loads, and a counter value S for assigning time stamps for stores.

In some embodiments, the processor supports a Total Store Order (TSO) memory model, wherein L and S are used to assign time stamps in non-decreasing order. In these embodiments, S is always greater-than-or-equal-to L.

In some embodiments, the counter value L remains fixed during speculative execution of the thread.

In some embodiments, the system maintains stores which arise during speculative execution in a store queue until after the speculative execution completes.

In some embodiments, after speculative execution completes, the system drains stores which arose during speculative execution from the store queue in program order. In these embodiments, while draining a store, the system first reads a time stamp from a cache line to which the store is directed. Next, if the counter value for the thread is less-than-or-equal-to the time stamp, the system performs the store to the cache line, increases the counter value to be greater than the time stamp, and then increases the time stamp to be greater-than-or-equal-to the (just increased) counter value. On the other hand, if the counter value is greater-than the time stamp, the system performs the store to the cache line and increases the time stamp to be greater-than-or-equal-to the counter value.

In some embodiments, if speculative execution fails, the system removes stores which arose during speculative execution from the store queue for the thread without committing the stores to the memory system of the processor.

In some embodiments, if the thread is executing non-speculatively and if a load causes a cache miss, the system defers the load and commences speculative execution of subsequent instructions without waiting for the load-miss to return.

In some embodiments, the system maintains a minimum value and a maximum value for a time stamp for each cache line. In these embodiments, when a thread performs a store to a cache line, the system updates the minimum value and the maximum value for the cache line to equal the thread's counter value for the store. On the other hand, when the thread performs a load from the cache line, the system increases the maximum value (but not the minimum value) to equal the time stamp for the load.

### BRIEF DESCRIPTION OF THE FIGURES

FIG. 1 illustrates a computer system in accordance with an embodiment of the present invention.

FIG. 2 illustrates state information associated with each thread in accordance with an embodiment of the present invention.

FIG. 3 presents a flow chart illustrating the steps involved in performing a load operation in accordance with an embodiment of the present invention.

FIG. 4 presents a flow chart illustrating the steps involved in performing a store operation in accordance with an embodiment of the present invention.

FIG. 5 presents a flow chart illustrating the steps involved in draining stores from the store queue in accordance with an embodiment of the present invention.

FIG. 6 presents a flow chart illustrating some of the steps involved in failing speculative execution in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

Embodiments of the present invention provide a memory system which enables loads to be reordered to improve processor utilization. To accomplish this without violating a memory model (such as TSO), the present invention assigns a logical time stamp to each load and store, which defines the position of the load or store in global memory order. These time stamps are associated with rules for specific memory models.

For example, under a sequential consistency (SC) memory model, each thread maintains a single counter value which is used to assign time stamps for both loads and stores. Under this model, time stamps for loads and stores are assigned in non-decreasing order.

In contrast, under a TSO memory model, each thread maintains a counter value L for assigning time stamps for loads, and a counter value S for assigning time stamps for stores. The counter values L and S are used to assign time stamps to loads in non-decreasing order and to stores in non-decreasing order, wherein the system ensures that S≧L.

For example, assume a thread executes a load from cache line A and the load generates a cache miss. Instead of waiting for cache line A to be returned from the memory hierarchy, the system can start executing subsequent instructions speculatively, which can involve deferring execution of the load and associated dependent instructions. During speculative execution, the counter value L remains fixed at a value of, say, 5. Next, assume that cache line A eventually returns from memory. At this point, the system performs the load from cache line A and also compares a time stamp from cache line A with the thread's counter value L (which we assume equals five). If the cache line's time stamp has the value 3 (which is less than L), we update the time stamp to equal 5. If the time stamp has the value 5 (which equals L), we leave the time stamp unchanged. On the other hand, if A has the value 7 (which is greater than L), we fail speculative execution for the thread because the non-decreasing rule for TSO has been violated (the time stamp for the load from A is 5, which is lower than the preceding time stamp of 7).

The above-described invention is described in more detail below, but first we describe how the invention fits into a computer system.

### Computer System

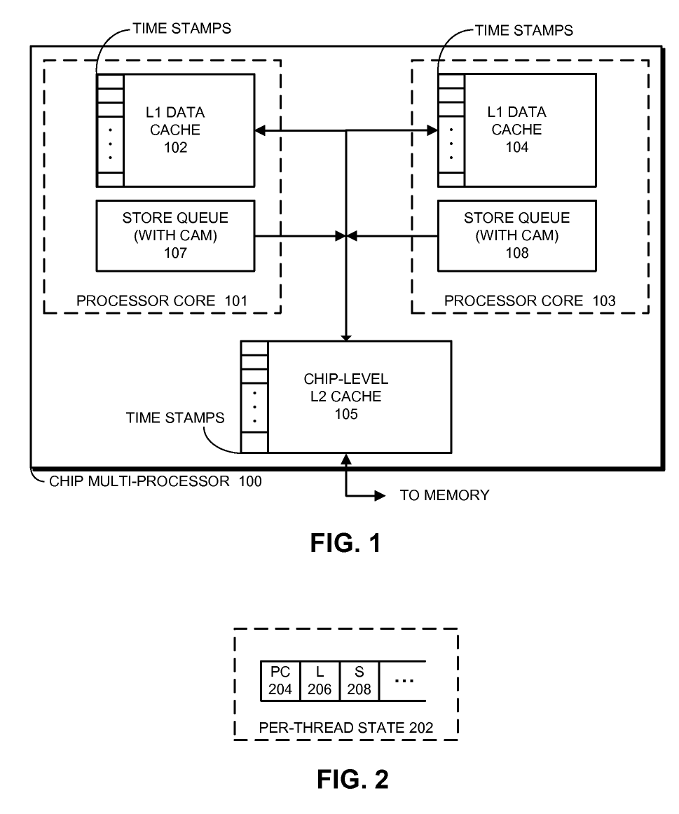

FIG. 1 illustrates an exemplary Chip Multi-Processor (CMP) system 100 in accordance with an embodiment of the present invention. CMP system 100 is incorporated onto a single semiconductor die, and includes two processor cores, 101 and 103.

Processor cores 101 and 103 include L1 data caches 102 and 104, respectively, and they share L2 cache 105. Along with L1 data caches 102 and 104, processor cores 101 and 103 include store queues 107 and 108, which buffer pending stores.

During a store operation in processor core 101, processor core 101 first performs a lookup for a corresponding cache line in L1 data cache 102. If the lookup generates a miss in L1 data cache 102 (or if store queue 107 is not empty), processor core 101 creates an entry for the store in store queue 107 and sends a corresponding request for the store to L2 cache 105.

During a subsequent load operation, processor core 101 uses a CAM structure to perform a lookup in store queue 107 to locate completed but not-yet-retired stores to the same address that are logically earlier in program order. For each byte being read by the load operation, if such a matching store exists, the load operation obtains its value from store queue 107 rather than from the memory subsystem. (This process is referred to as a “RAW-bypassing operation”.)

Note that each cache line in L1 data cache 102, L1 data cache 104, and L2 cache 105, as well as in the memory (not shown) can include a time stamp. This time stamp can be used to facilitate reordering of load instructions. We discuss how this time stamp is used in more detail below.

### State Information for Threads

FIG. 2 illustrates state information associated with each thread in accordance with an embodiment of the present invention. This state information includes conventional thread-specific state information, such as a program counter (PC) 204. It also includes and one or more counters which are used to set time stamps in cache lines. For example, FIG. 2 illustrates a load counter (L) 206 and a store counter (S) 208 which are described in more detail below.

### Load Operation

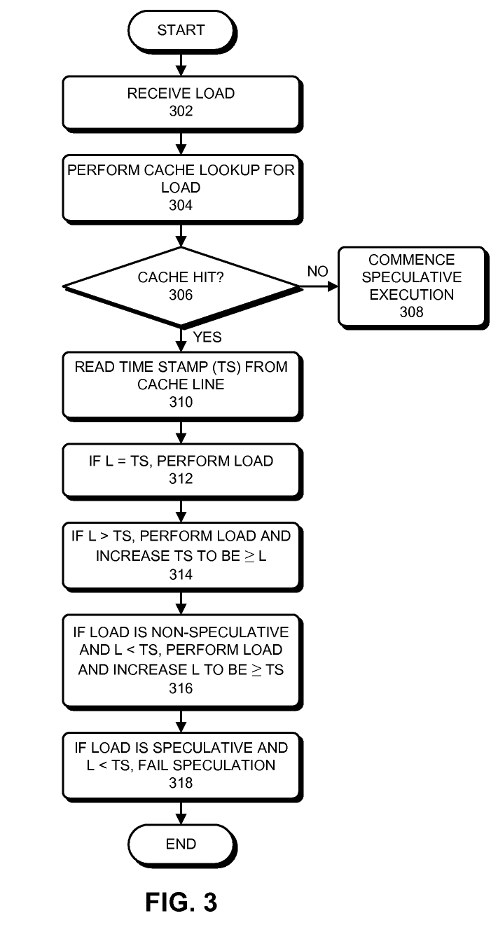

FIG. 3 presents a flow chart illustrating the steps involved in performing a load operation for a thread in accordance with an embodiment of the present invention. Note that the system maintains a counter value L for assigning time stamps for loads, and a counter value S for assigning time stamps for stores. At the start of the load operation, the system receives a load instruction which includes a load address (step 302). Next, the system performs a cache lookup based on the load address (step 304).

In one embodiment of the present invention, if the cache lookup results in a cache miss at step 306, instead of waiting for the cache line to return from the memory hierarchy, the system starts executing subsequent instructions speculatively, which can involve deferring execution of the load and associated dependent instructions (step 308). (For example, see U.S. Pat. No. 7,114,060, entitled, “Selectively Deferring the Execution of Instructions with Unresolved Data Dependencies as They Are Issued in Program Order,” by inventors Shailender Chaudhry and Marc Tremblay, filed 14 Oct. 2003. This patent is hereby incorporated by reference to disclose details of how a processor can support deferred execution.)

In one embodiment of the present invention, all loads which are executed during a speculative episode receive the same time stamp value L (that is, L cannot be increased during the speculative episode). Next, when the cache line for the initial load which started the speculation returns from the memory system, the deferred instructions are executed and the system commits the entire speculative episode. As long as the same time stamp value L can be used by the thread during the entire speculative episode without violating the rules for the memory model, the speculation is successful. (Note that the present invention can alternatively be used with an out-of-order execution model instead of a deferred-execution model. In an out-of order execution model, all loads which are executed between instructions commits are considered to be part of the same speculative episode and hence receive the same time stamp value L.)

Referring back to the cache lookup in step 304, if the cache lookup results in a cache hit at step 306, the system reads a time stamp (TS) from a cache line to which the load is directed (step 310). Next, if the counter value L is equal to the time stamp TS, the system performs the load (step 312). Otherwise, if the counter value L is greater-than the time stamp TS, the system performs the load and increases the time stamp TS to be greater-than-or-equal-to the counter value L (step 314).

If the load is a non-speculative load, and the counter value is less-than the time stamp, the system performs the load and increases the counter value to be greater-than-or-equal-to the time stamp (step 316).

On the other hand, if the load is a speculative load, which is speculatively performed earlier than an older load in program order, and the counter value is less-than the time stamp, the system fails speculative execution for the thread (step 318).

### Store Operation

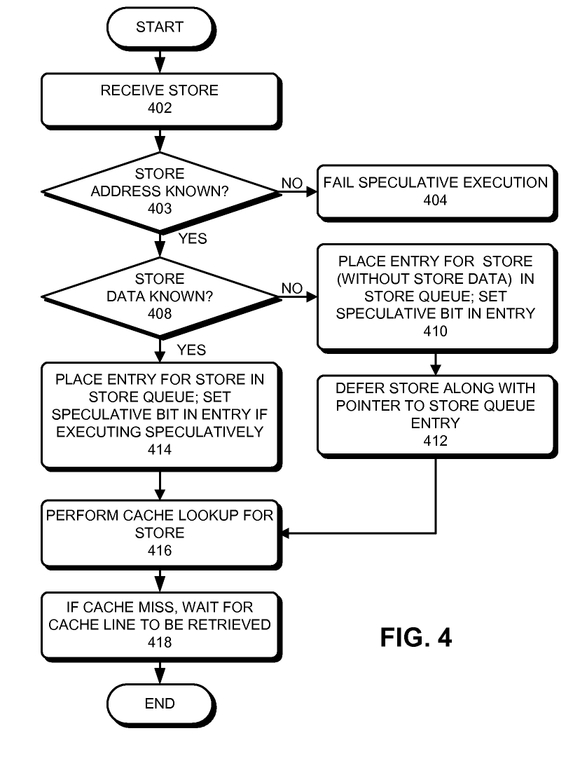

FIG. 4 presents a flow chart illustrating the steps involved in performing a store operation in accordance with an embodiment of the present invention. At the start of the store operation, the system receives a store instruction (step 402). Next, the system determines whether the associated store address is known (step 403). (Note that the store address and/or store data may not be known if the thread is executing speculatively.) If the store address is not known, the system fails speculative execution and rolls back to a preceding checkpoint (step 404). On the other hand, if the store address is known, the system determines whether the store data is known (step 408). If the store data is known, the system places an entry for the store in the store queue, wherein the entry includes data bytes and a byte mask. The system also sets a “speculative bit” in the entry if the store thread is executing speculatively (step 414).

On the other hand, if the store data is not known at step 408, and if the processor architecture supports deferred execution, the system places an entry for the store in the store queue without the store data (which can possibly involve setting a not-there (NT) bit for the entry). The system also sets a speculative bit for the entry to indicate that the entry should not be drained until speculative execution for the thread completes (step 410). The system then defers the store (along with a pointer to the store queue entry) (step 412). At a later time, when the store data becomes known, the store is replayed and the pointer is used to write the store data into the associated store queue entry. (Note that if the system subsequently performs a RAW-bypass operation that matches a store queue entry which does not have a data value, the system can treat the associated load operation as a load-miss which must wait for the store data to become known.) Finally, after either step 412 or step 414 completes, the system performs a cache lookup for the store (step 416). If the cache lookup results in a cache miss, the system waits for the coherence protocol to obtain the cache line in a writeable state in the local cache (step 418).

### Draining Stores

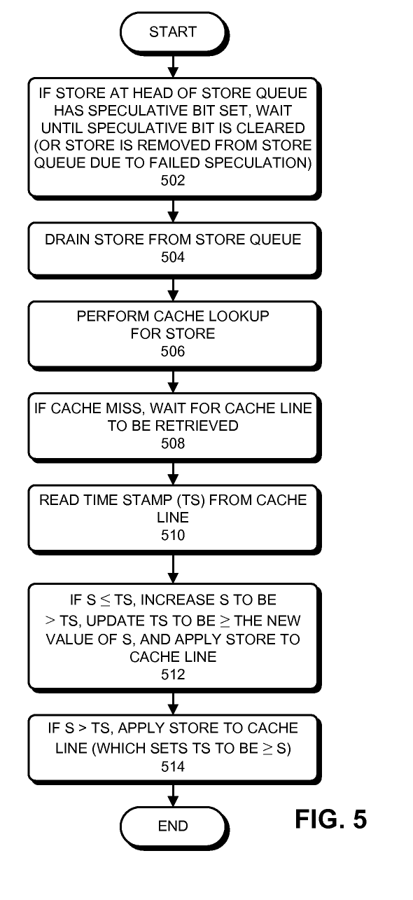

FIG. 5 presents a flow chart illustrating the steps involved in draining stores from a store queue in accordance with embodiments of the present invention. In these embodiments, if a store at the head of a store queue has its speculative bit set, the system waits until the speculative bit is cleared (or the store is removed from the store queue due to failed speculation) (step 502). Next, the system drains the store from the store queue (step 504). The system then performs a cache lookup for the store to retrieve a cache line to which the store is directed (step 506). If the cache lookup results in a cache miss, the system waits for the cache line to be retrieved (step 508). Next, the system reads a time stamp (TS) from a cache line (step 510). If the store counter value S for the thread is less-than-or-equal-to the time stamp TS, the system increases S to be >TS. The system also updates TS to be ≧the new value of S and applies the store to the cache line (step 512). On the other hand, if S>TS, the system applies the store to the cache line which sets TS to be ≧S (step 514).

### Failing Speculation

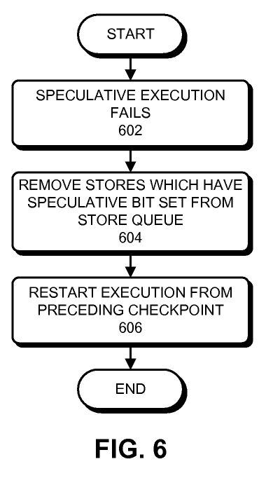

FIG. 6 presents a flow chart illustrating some of the steps involved in failing speculative execution in accordance with an embodiment of the present invention. At the start of this process, speculative execution fails (step 602). This failure can occur for a number of reasons. (For example, in step 318 in the flow chart illustrated in FIG. 3, if a thread performing a speculative load has a load counter value L which is less than a time stamp for a cache to which the load is directed, a memory model rule is violated, which causes speculative execution to fail.) The system then removes stores which have their speculative bits set from the store queue for the thread (step 604). Next, the thread restarts execution from a preceding checkpoint (step 606).

### Supporting Ranges for Time Stamps

In one embodiment of the present invention, the system is extended to support a min-max range for each time stamp on a cache line. In this embodiment, instead of storing a single time stamp value for each cache line, the system stores a minimum value (min) and a maximum value (max) for the time stamp. Whenever a thread performs a store to a cache line, the thread updates min and max to equal the time stamp for that store. In contrast, whenever the thread performs a load to a cache line, the thread only has to increase max to equal the time stamp for the load; min is not updated. This allows loads which fall in the range of time stamp values defined by min and max to succeed, whereas maintaining a single time stamp value (instead of a range) might cause a load to fail.

For example, assume for a given cache line that min=max=5. If a thread with a load counter value L=7 performs a load from the cache line, max is increased to 7, but min stays at 5. Next, if another thread with a load counter value L=6 attempts to load from the same cache line, the load will succeed because 6 is in the range from 5 to 7. Note that a system that maintains only a single time stamp would have updated the time stamp to 7 during the first load, and the second load (from the thread with L=6) would have failed.

### Conclusion

The above-described invention, which uses logical time stamps to support load re-ordering, provides a number of advantages over existing techniques. Unlike existing techniques, the present invention enables a processor to perform out-of-order speculative loads from an unbounded number of cache lines. Moreover, the system does not have to remove load marks (or load mark counts) from cache lines after speculative execution completes. Additionally, if another thread wants to store to a cache line that a speculative thread has loaded from, the other thread does not have to wait for the speculative thread to complete the speculative episode. All of the above-listed advantages can significantly improve system performance.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for supporting load reordering in a processor, comprising:
maintaining at least one counter value for a thread which is used to assign time stamps for the thread;
while performing a load for the thread, reading a time stamp from a cache line to which the load is directed;
if the counter value is equal to the time stamp, performing the load;
if the counter value is greater-than the time stamp, performing the load and increasing the time stamp to be greater-than-or-equal-to the counter value; and
if the load is a speculative load, which is speculatively performed earlier than an older load in program order, and the counter value is less-than the time stamp, failing speculative execution for the thread.

2. The method of claim 1, wherein if the load is a non-speculative load and the counter value is less-than the time stamp, performing the load and increasing the counter value to be greater-than-or-equal-to the time stamp.

3. The method of claim 1, wherein the processor supports a sequential consistency (SC) memory model, wherein the thread maintains a single counter value which is used to assign time stamps for both loads and stores, wherein time stamps for loads and stores are assigned in non-decreasing order.

4. The method of claim 1, wherein the thread maintains a counter value L for assigning time stamps for loads, and a counter value S for assigning time stamps for stores.

5. The method of claim 4, wherein the processor supports a Total Store Order (TSO) memory model, wherein L and S are used to assign time stamps in non-decreasing order, and wherein S is always greater-than-or-equal-to L.

6. The method of claim 1, wherein the counter value L remains fixed during speculative execution of the thread.

7. The method of claim 1, further comprising maintaining stores which arise during speculative execution in a store queue until after the speculative execution completes.

8. The method of claim 7, wherein after speculative execution completes, the method further comprises draining stores which arose during speculative execution from the store queue in program order, wherein draining a store involves:
reading a time stamp from a cache line to which the store is directed;
if the counter value for the thread is less-than-or-equal-to the time stamp, performing the store to the cache line, increasing the counter value to be greater than the time stamp, and then increasing the time stamp to be greater-than-or-equal-to the (just increased) counter value; and
if the counter value is greater-than the time stamp, performing the store to the cache line and increasing the time stamp to be greater-than-or-equal-to the counter value.

9. The method of claim 7, wherein if speculative execution fails, the method further comprises removing stores which arose during speculative execution from the store queue for the thread without committing the stores to the memory system of the processor.

10. The method of claim 1, further comprising:
maintaining a minimum value and a maximum value for a time stamp for each cache line;
wherein when a thread performs a store to a cache line, the thread updates the minimum value and the maximum value for the cache line to equal the thread's counter value for the store; and
wherein when the thread performs a load from the cache line, the thread only increases the maximum value but not the minimum value to equal the time stamp for the load.

11. An apparatus that supports load reordering in a processor, comprising:
the processor;
at least one counter within the processor containing a counter value which is used to assign time stamps for a thread; and
an execution mechanism within the processor;
wherein while performing a load for the thread, the execution mechanism is configured to read a time stamp from a cache line to which the load is directed;
wherein if the counter value is equal to the time stamp, the execution mechanism is configured to perform the load;
wherein if the counter value is greater-than the time stamp, the execution mechanism is configured to perform the load and to increase the time stamp to be greater-than-or-equal-to the counter value; and
wherein if the load is a speculative load, which is speculatively performed earlier than an older load in program order, and if the counter value is less-than the time stamp, the execution mechanism is configured to fail speculative execution for the thread.

12. The apparatus of claim 11, wherein if the load is a non-speculative load and the counter value is less-than the time stamp, the execution mechanism is configured to perform the load and to increase the counter value to be greater-than-or-equal-to the time stamp.

13. The apparatus of claim 11, wherein the processor supports a sequential consistency (SC) memory model, wherein the processor maintains a single counter value for the thread which is used to assign time stamps for both loads and stores, wherein time stamps for loads and stores are assigned in non-decreasing order.

14. The apparatus of claim 11, wherein the processor maintains a counter value L for assigning time stamps for loads for the thread, and a counter value S for assigning time stamps for stores for the thread.

15. The apparatus of claim 14, wherein the processor supports a Total Store Order (TSO) memory model, wherein L and S are used to assign time stamps in non-decreasing order, and wherein S is always greater-than-or-equal-to L.

16. The apparatus of claim 11, wherein the counter value L remains fixed during speculative execution of the thread.

17. The apparatus of claim 11, wherein the processor is configured to maintain stores which arise during speculative execution in a store queue until after the speculative execution completes.

18. The apparatus of claim 17, wherein after speculative execution completes, the processor is configured to drain stores which arose during speculative execution from the store queue in program order, wherein draining a store involves:
reading a time stamp from a cache line to which the store is directed;
if the counter value for the thread is less-than-or-equal-to the time stamp, performing the store to the cache line, increasing the counter value to be greater than the time stamp, and then increasing the time stamp to be greater-than-or-equal-to the (just increased) counter value; and
if the counter value is greater-than the time stamp, performing the store to the cache line and increasing the time stamp to be greater-than-or-equal-to the counter value.

19. The apparatus of claim 17, wherein if speculative execution fails, the processor is configured to remove stores which arose during speculative execution from the store queue for the thread without committing the stores to the memory system of the processor.

20. A computer system that supports load reordering in a processor, comprising:
the processor;
a memory;
at least one counter within the processor containing a counter value which is used to assign time stamps for a thread; and
an execution mechanism within the processor;
wherein while performing a load for the thread, the execution mechanism is configured to read a time stamp from a cache line to which the load is directed;
wherein if the counter value is equal to the time stamp, the execution mechanism is configured to perform the load;
wherein if the counter value is greater-than the time stamp, the execution mechanism is configured to perform the load and to increase the time stamp to be greater-than-or-equal-to the counter value; and
wherein if the load is a speculative load, which is speculatively performed earlier than an older load in program order, and if the counter value is less-than the time stamp, the execution mechanism is configured to fail speculative execution for the thread.
